(19) United States
(12) Patent Application Publication
(10) Pub. No.: US 2001/0048838 A1
(43) Pub. Date: Dec. 6, 2001

(54) Paint container

(76) Inventor: Andre Daigle, Boucherville (CA)

Correspondence Address: COLLARD & ROE, P.C., 1077 Northern Boulevard, Roslyn, NY, 11576-1696, US

(21) Appl. No.: 09/741,883

(22) Filed: Dec. 22, 2000

Related U.S. Application Data
(60) Provisional application No. 60/172,992, filed on Dec. 21, 1999.

(51) Int. Cl. A47L 11/08; A46B 11/00; B05C 17/00

(52) U.S. Cl. 401/21; 401/16; 401/208

(57) ABSTRACT

A self-contained paint container for storing leftover paint. The self-contained paint container has a hollow body sized and shaped to be held in one hand. The hollow body has a first and second opposite ends. The first and second ends being each provided with a removable cover. The first end is provided with a roller and a paint expeller for allowing controlled release of paint on the roller. The roller may be covered by a cover, which is provided with an absorbent material for preventing the paint on the roller to dry out upon storage. The second end is provided with a cover, of which can further include a brush thereon.

### FIELD OF THE INVENTION

The present invention is concerned with a paint container. More precisely, it is concerned with a hand held self-contained paint container.

### BACKGROUND OF THE INVENTION

Professionals and homeowners alike are often inconvenienced by leftover paint at the bottom of cans or gallons that are difficult to store properly for later use. The containers are often bulky and take too much room, and the paint therein tends to dry out after a while.

Known in the art are paint trays provided with covers for separate storing, but they do not improve much on the above-mentioned drawbacks. There is therefore a need for a paint container that solves the above-mentioned problems.

### SUMMARY OF THE INVENTION

A first object of the present invention is to provide a self-contained paint container comprising an integrated roller and paint brush.

A second object of the invention is to provide a paint container that is compact enough to be hand held.

In accordance with the invention, these objects are achieved with a self-contained paint container for storing leftover paint, the paint container having a hollow body designed to store the leftover paint therein, the hollow body having a first and second opposite ends,

the first end being provided with a roller and comprising a paint expeller for allowing a controlled release of paint on the roller, and

the second end having a cover adapted to receive a paint brush thereon, the paint brush comprising a brush portion and a shaft portion.

An advantage of the paint container of the present invention is that it allows storage of leftover paint in a smaller container thus preventing paint to dry over time. Because the container is smaller, it also allows to save storage space.

Another advantage of the paint container of the present invention is that it comprises its own painting tools therefor the same tools are reused every time and no cleaning of painting tools is required after each use.

The present invention and its advantages will be more easily understood after reading the following non-restrictive description of preferred embodiments thereof, made with reference to the appended drawings.

### BRIEF DESCRIPTION OF THE DRAWINGS

FIG. 1 is a perspective view of the self-contained paint container according to a preferred embodiment of the present invention.

FIGS. 2 and 3 are exploded perspective views of the self-contained paint container of FIG. 1.

FIG. 4 is partly fractioned exploded view of the self-contained container of FIG. 1.

### DETAILED DESCRIPTION OF THE INVENTION

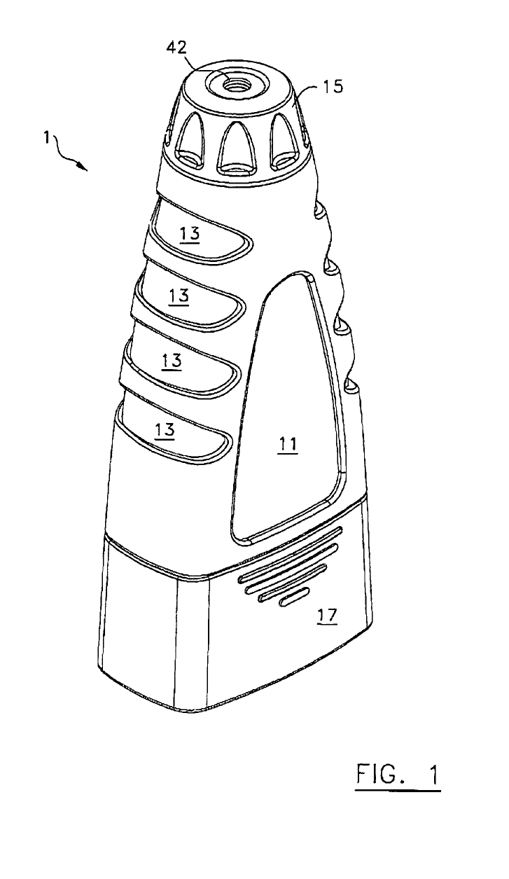

As can be seen in FIG. 1, the self-contained paint container 1 of the present invention is designed to be compact enough to be hand held. The self-contained paint container 1 comprises a hollow body 11 designed to store the left over paint therein. The hollow body 11 may be provided with gripping means 13 on the outside thereof for facilitating the manipulation of the paint container. The hollow body 11 has a longitudinal axis which extends between a first and second opposite ends.

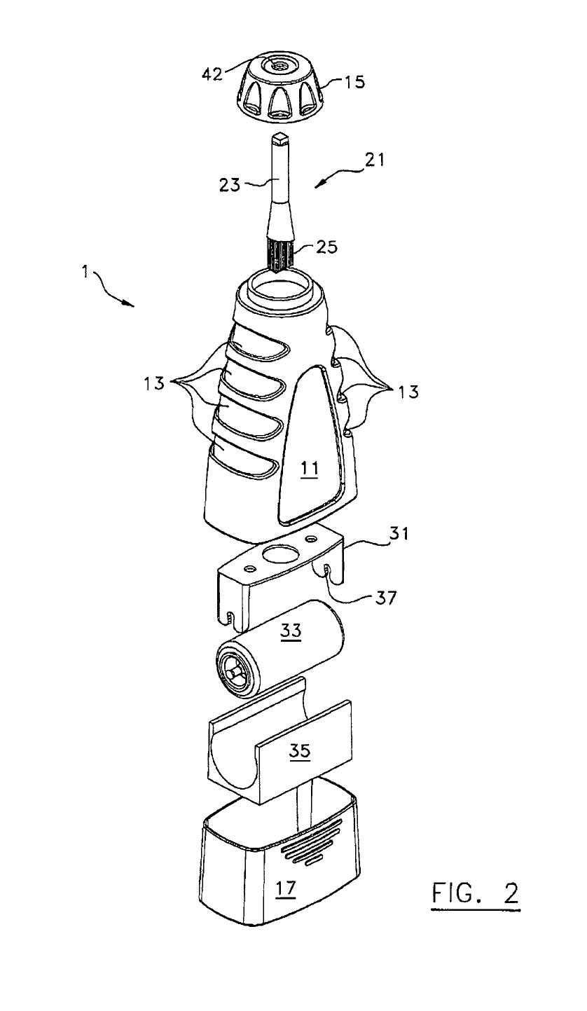

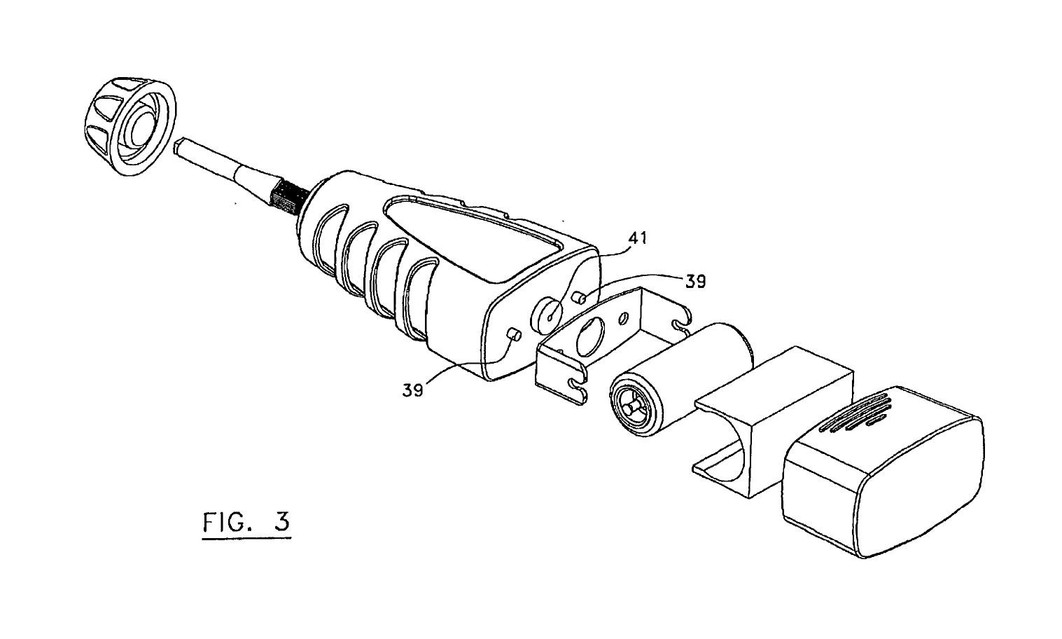

Referring now to FIGS. 2 and 3, the first end is provided with a roller 33 and further comprises a paint expeller for allowing a controlled release of paint on the roller 33. As best seen in FIG. 3, the paint expeller may be a flexible membrane 41 having a notch thereon to permit a user to expel paint from the container upon pressure applied to the hollow body 11.

Still referring to FIGS. 2 and 3, the second end has a cover 15 that is adapted to receive a paint brush 21. The paint brush 21 has a brush portion 25 and a shaft portion 23. In the illustrated embodiment, the paint brush 21 is mounted on an inner face of the cover 15. Preferably, the cover 15 may be provided with a threaded cavity 42 so as to allow an extremity of an extension poll to be removably inserted therein, thereby allowing a user of the container to reach elevated areas, such as a ceiling, high walls for examples as is known to one skilled in the art.

As seen in the illustrated embodiment, the roller 33 is secured on the second end of the paint container 11 by a support 31. The support 31 has two arms which extends parallel from each other from the second end. Each arm has an extremity 37 adapted to receive a corresponding end of the roller 33 thereon. The arms being spaced apart by a distance which is smaller than the diameter of the hollow body 11.

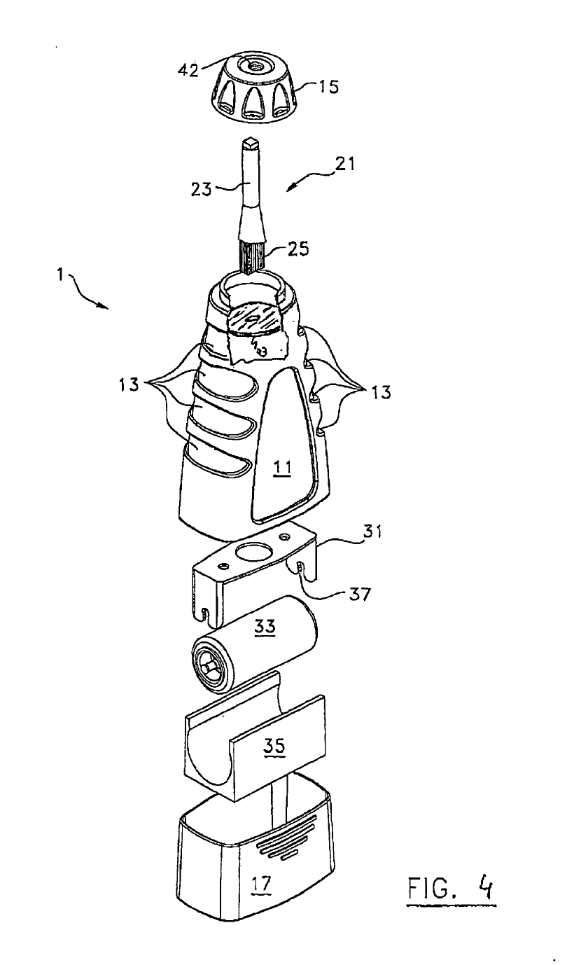

The roller 33 preferably has a rotation axis that is perpendicular to the longitudinal axis of the hollow body 11. As shown in FIG. 4, preferably, the container 1 further comprises at the second opposite end, a flexible membrane 43 having a slot shaped and sized to receive the shaft portion of the paint brush and wipe away excess paint on the shaft during removal of the paint brush from the hollow body.

The container 1 may also include a removable cover 17 for fitting over the roller 33. The cover 17 comprises an absorbent material 35 suitable for preventing the roller 33 to dry upon storage of the paint container 1. Preferably, the material is selected from the group consisting of polyurethane, polyethylene and melanin.

As best seen in FIG. 3, the first end of the hollow body 11 may further comprise a pair of protruding buttons 39 made of the same moulded material than the hollow body 11. The buttons 39 are provided as securing means for fixing the support 31 to the hollow body 11. When the support 31 is mounted on the hollow body 11, the buttons 39 are melted by heat thereby sealing the two pieces together. However, a variety of different means to fasten the support or roller to the body are well within the scope of the present invention.

Although the present invention has been explained herein above by way of a preferred embodiment thereof, it should be pointed out that any modifications to this preferred embodiment within the scope of the present invention is not deemed to alter or change the nature and scope of the present invention.

1. A self-contained paint container for storing leftover paint, the paint container having a hollow body designed to store the leftover paint therein, the hollow body having a first and second opposite ends,
the first end being provided with a roller and comprising a paint expeller for allowing a controlled release of paint on the roller, and
the second end having a cover adapted to receive a paint brush thereon, the paint brush comprising a brush portion and a shaft portion.

2. A self-contained paint container according to claim 1, wherein the roller has a rotation axis that is perpendicular to a longitudinal axis of the hollow body.

3. A self-contained paint container according to claim 1, wherein the roller is secured to the first end of the paint container by a support, the support comprising two parallel arms, each arm having an extremity adapted to receive a corresponding end of the roller thereon, the arms being spaced apart by a distance that is smaller than a diameter of the hollow body.

4. A self-contained paint container according to claim 1, wherein the paint expeller comprises a flexible membrane having a notch.

5. A self-contained paint container according to claim 1, further comprising a removable cover for fitting over the roller, the cover comprising an absorbent material therein for preventing the roller to dry upon storage of the paint container.

6. A self-contained paint container according to claim 6, wherein the absorbent material is selected from the group consisting of polyethylene, polyurethane and melanin.

7. A self-contained paint container according to claim 1, wherein the hollow body is provided with gripping means on the outside thereof for facilitating the manipulation of the paint container.

8. A self-contained paint container according to claim 1, wherein the paint brush is mounted on an inner face of the cover.

9. A self-contained paint container according to claim 8, wherein the second end of the paint container further comprises a membrane having a slot shaped and sized to receive the shaft portion of the paint brush and wipe away excess paint on the shaft during removal of the paint brush from the hollow body.
